(19) United States
(12) Patent Application Publication
(10) Pub. No.: US 2024/0114423 A1
(43) Pub. Date: Apr. 4, 2024

(54) COMMUNICATION ROUTE SEARCH METHOD, GROUND SYSTEM, SURVEILLANCE SATELLITE CONSTELLATION, COMMUNICATION SATELLITE CONSTELLATION, FLYING OBJECT COPING SYSTEM, UNIFIED DATA LIBRARY, SATELLITE, AND SATELLITE CONSTELLATION

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/276,040

(22) PCT Filed: Feb. 16, 2022
(86) PCT No.: PCT/JP2022/006107

§ 371 Date: Aug. 7, 2023

(30) Foreign Application Priority Data
Feb. 19, 2021 (JP) 2021-024774

(51) Int. Cl. H04W 40/02; B64G 1/10; F41H 11/02; H04B 7/185

(52) U.S. Cl. CPC H04W 40/02; B64G 1/1007; B64G 1/1028; B64G 1/1085; F41H 11/02; H04B 7/18513; H04B 7/18519

(57) ABSTRACT

In a communication route search method, a ground system includes a communication route search device and a model database that stores a plurality of flight path models, which are a plurality of modeled flight paths. A communication route search device selects a subsequent surveillance satellite that can monitor a flight path at a predicted time by using a plurality of flight path models, starting at launch detection information of a flying object detected by a surveillance satellite and repeats a shortest route search for transmitting information to the subsequent surveillance satellite and then the next subsequent surveillance satellite. After repeating the route search, the communication route search device searches for the shortest route through which information is transmitted from a last subsequent surveillance satellite in the shortest route search to a coping asset that can cope with the flying object.

### DESCRIPTION

### Technical Field

The present disclosure relates to a flight path prediction method, a ground system, a flight path model, a flight path prediction device, a flying object tracking system, a flying object coping system, a unified data library, a satellite, and a satellite constellation.

### Background Art

There is a technology for comprehensively monitoring an area at a specific latitude within the global surface of the earth using a satellite constellation (for example, Patent Literature 1).

In addition, there is a technology for predicting the path of a flying object in a ballistic orbit by using a flight path model. Regarding this technology, a flying object that repeats an intermittent injection, which is referred to as a glide bullet, has emerged in recent years. It is necessary to address such a glide bullet.

In order to address a flying object, such as a ballistic flying object or a glide bullet, the surveillance information of the flying object monitored by a surveillance satellite needs to be transmitted from the surveillance satellite to another surveillance satellite and finally from surveillance satellite to a coping asset. For this purpose, a communication route needs to be quickly and accurately searched for.

### CITATION LIST

### Patent Literature

Patent Literature 1: JP 2008-137439

### SUMMARY OF INVENTION

### Technical Problem

An object of the present disclosure is to provide a communication route search method that quickly and accurately searches for a communication route for transmitting flying object information detected by a surveillance satellite.

### Solution to Problem

A communication route search method of searching for a shortest communication route among communication routes of a communication satellite group including a plurality of communication satellites, the communication route search method being used by a flying object coping system that performs coping by using a coping asset before landing of a flying object, by transmitting flying object surveillance information obtained by a surveillance satellite of a surveillance satellite constellation including a plurality of surveillance satellites each having an infrared surveillance device to another surveillance satellite and the coping asset by using, as a transmission path, a communication satellite constellation in which the communication satellite group flies on individual orbital planes of a plurality of orbital planes and the communication satellites form a cross-link to each other to form a communication network, and the flying object coping system having a ground system, wherein
the ground system has
   a communication route search device to analyze
      communication satellite IDs of individual communication satellites of the plurality of communication satellites that form a communication path through which the flying object surveillance information is transmitted from the surveillance satellite to the other surveillance satellite in a shortest route,
      an order of the communication satellite IDs of the plurality of communication satellites in which the flying object surveillance information chronologically passes through the plurality of communication satellites, and
      times at which the individual communication satellites of the plurality of communication satellites communicate with each other, and
   a model database to store a plurality of flight path models that are a plurality of modeled flight paths each including launch position coordinates, a flight direction, a chronological flight distance from launch to landing, and flight altitude profile of the flying object,
the communication route search device
   selects a subsequent surveillance satellite that can monitor a flight path at a predicted time by using the plurality of flight path models, starting at launch detection information of the flying object detected by the infrared surveillance device of the surveillance satellite,
   performs a shortest route search for transmitting information, to the subsequent surveillance satellite, from the surveillance satellite having the infrared surveillance device that detected the launch detection information of the flying object,
   selects a next subsequent surveillance satellite that can monitor the flight path at a predicted time by using the flight path model as a candidate based on the flying object surveillance information detected by the subsequent surveillance satellite,
   performs a shortest route search for transmitting information from the subsequent surveillance satellite to the next subsequent surveillance satellite, and
   repeats the shortest route search for transmitting information to the surveillance satellite that can monitor the flying object and searches for a shortest route through which information is transmitted from a last subsequent surveillance satellite in the shortest route search to the coping asset that can cope with the flying object.

### Advantageous Effects of Invention

According to the present disclosure, it is possible to provide a communication route search method that can quickly and accurately search for a communication route for transmitting flying object information detected by a surveillance satellite.

### BRIEF DESCRIPTION OF DRAWINGS

FIG. 1 is a diagram of Embodiment 1, illustrating a communication route search method 471.

FIG. 2 is a diagram of Embodiment 1, illustrating an example of the structure of a satellite constellation forming system 600.

FIG. 3 is a diagram of Embodiment 1, illustrating an example of the structure of a satellite 620 of the satellite constellation forming system 600.

FIG. 4 is a diagram of Embodiment 1, illustrating an example of a flight path model of a flying object 520 a flying object 520 as viewed from a certain altitude.

FIG. 5 is a diagram of Embodiment 1, illustrating an example of a flight path model of a ballistic flying object represented by the distance direction and the height direction.

FIG. 6 is a diagram of Embodiment 1, illustrating a flight path model of a flying object that performs an intermittent injection.

FIG. 7 is a diagram of Embodiment 1, illustrating a block structure diagram of a ground system 340.

FIG. 8 is a diagram of Embodiment 2, illustrating the layout of a unified data library.

FIG. 9 is a diagram of Embodiment 2, illustrating the hardware structure of the unified data library.

FIG. 10 is a diagram of Embodiment 2, illustrating a satellite having an edge server.

FIG. 11 is a diagram of Embodiment 2, illustrating a satellite having an artificial intelligence calculator.

FIG. 12 is a diagram of Embodiment 2, illustrating a satellite constellation having a ring communication network and a mesh communication network.

### DESCRIPTION OF EMBODIMENTS

In the descriptions and drawings of embodiments, identical components and corresponding components are denoted by identical reference characters. The description of components with the same reference characters are omitted or simplified as appropriate. In the embodiments below, “unit” may be read as “circuit”, “process”, “procedure”, “processing”, or “circuitry” as appropriate.

### Embodiment 1

### Description of Structure

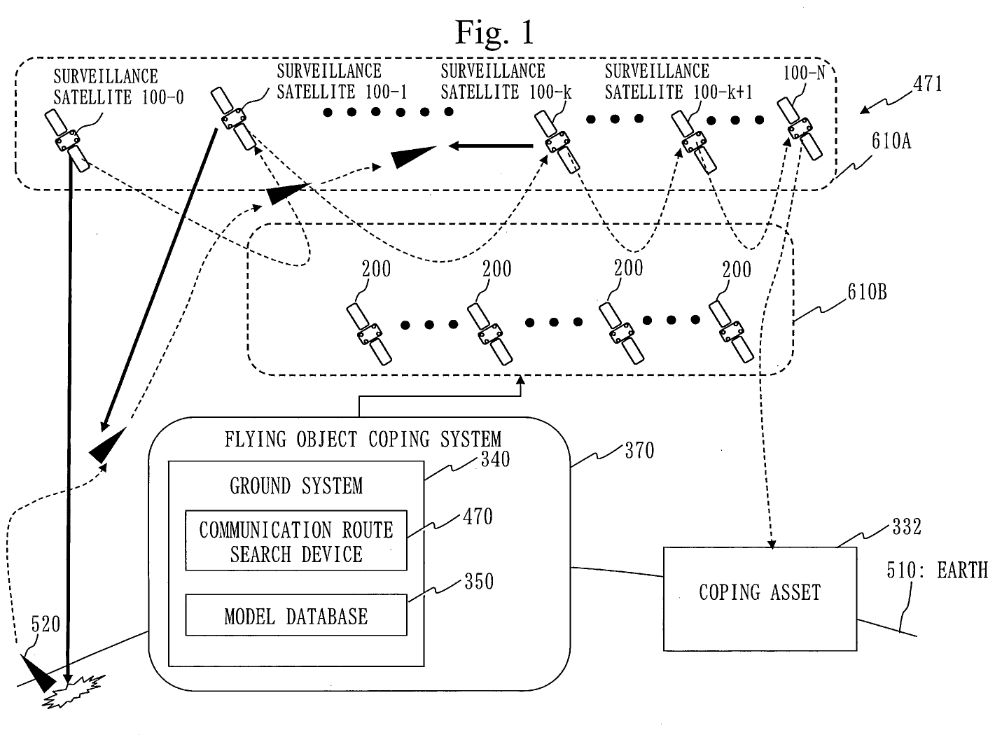

FIG. 1 is a diagram illustrating a communication route search method 471. Details of FIG. 1 will be described later.

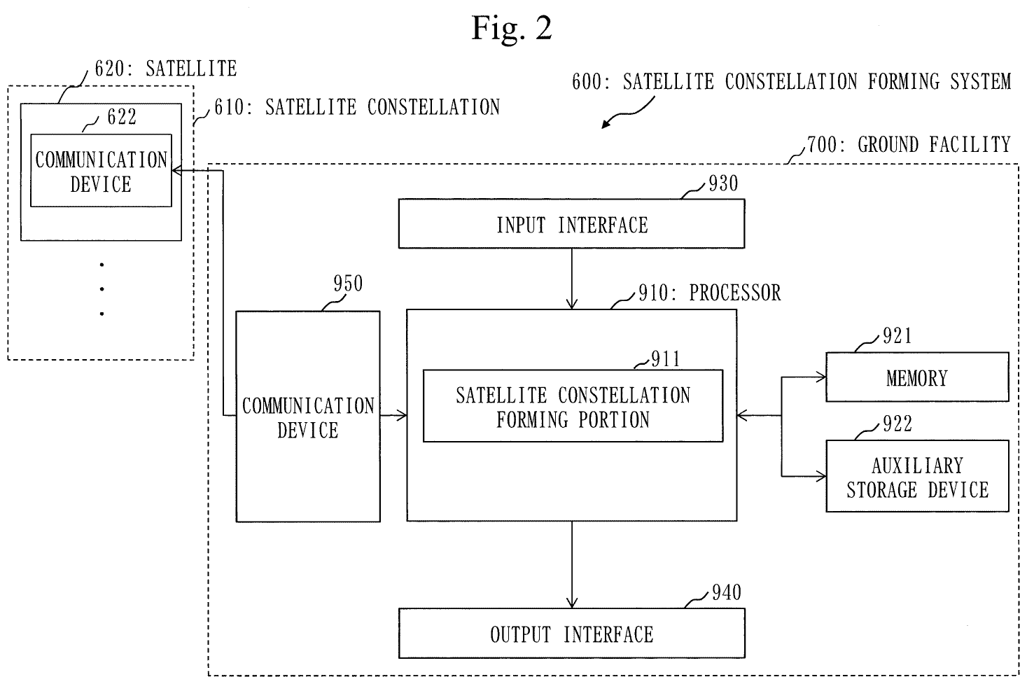

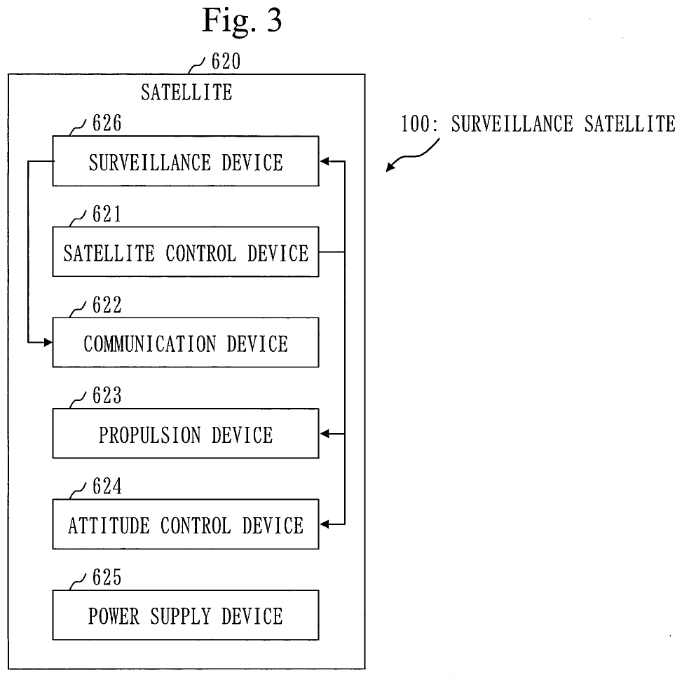

An example of satellites 620 and a ground facility 700 of a satellite constellation forming system 600 that constitutes a satellite constellation 610 will be described with reference to FIGS. 2 and 3. The satellite constellation 610 is an integrated satellite constellation. The satellite constellation forming system 600 is often referred to simply as the satellite constellation.

FIG. 2 is an example of the structure of the satellite constellation forming system 600. The satellite constellation forming system 600 includes a computer. FIG. 2 illustrates a structure having one computer, but actually, the individual satellites 620 of the plurality of satellites constituting the satellite constellation 610 and the ground facility 700 that communicates with the satellites 620 has a computer. In addition, the computers provided in the individual satellites 620 of the plurality of satellites and the computers provided in the ground facility 700 that communicates with the satellites 620 cooperate with each other to achieve the function of the satellite constellation forming system 600. An example of the structure of the computer that achieves the function of the satellite constellation forming system 600 will be described below.

The satellite constellation forming system 600 includes the satellites 620 and the ground facility 700. Each of the satellites 620 includes a communication device 622 that communicates with a communication device 950 of the ground facility 700. FIG. 2 illustrates the communication device 622 among the components of the satellite 620.

The satellite constellation forming system 600 includes a processor 910 and other hardware such as a memory 921, an auxiliary storage device 922, an input interface 930, an output interface 940, and a communication device 950. The processor 910 is connected to the other hardware via signal lines to control the other hardware.

The satellite constellation forming system 600 includes a satellite constellation forming unit 911 as a functional element. The function of the satellite constellation forming unit 911 is achieved by hardware or software. The satellite constellation forming unit 911 controls the formation of the satellite constellation 610 while communicating with satellites 620.

FIG. 3 is an example of the structure of each of the satellites 620 of the satellite constellation forming system 600. The satellite 620 includes a satellite control device 621, the communication device 622, a propulsion device 623, an attitude control device 624, a power supply device 625, and a surveillance device 626. The satellite 620 may include other components that achieve various functions, but the satellite control device 621, the communication device 622, the propulsion device 623, the attitude control device 624, the power supply device 625, and the surveillance device 626 will be described with reference to FIG. 3. The satellite 620 in FIG. 3 is an example of a surveillance satellite 100.

The satellite control device 621 is a computer that controls the propulsion device 623 and the attitude control device 624 and has a processing circuit. Specifically, the satellite control device 621 controls the propulsion device 623 and the attitude control device 624 according to various commands sent from the ground facility 700.

The communication device 622 communicates with the ground facility 700. Alternatively, the communication device 622 communicates with the front and rear satellites 620 on the same orbital plane or the satellites 620 on adjacent orbital planes. Specifically, the communication device 622 sends various types of data regarding the satellite to which the communication device 622 belongs to the ground facility 700 or other satellites 620. In addition, the communication device 622 receives various commands sent from the ground facility 700.

The propulsion device 623 provides a propulsion force to the satellite 620 and changes the speed of the satellite 620.

The attitude control device 624 controls attitude elements, such as the attitude of the satellite 620 and the angular velocity and the line of sight of the satellite 620. The attitude control device 624 changes the attitude elements in a desired direction. Alternatively, the attitude control device 624 maintains the attitude elements in a desired direction. The attitude control device 624 includes an attitude sensor, an actuator, and a controller. The attitude sensor is a device such as a gyroscope, an earth sensor, a sun sensor, a star tracker, a thruster, or a magnetic sensor. The actuator is a device such as an attitude control thruster, a momentum wheel, a reaction wheel, or a control moment gyro. The controller controls the actuator according to the measurement data from the attitude sensor or various commands from the ground facility 700.

The power supply device 625 includes devices, such as a solar cell, a battery, and a power control device, and supplies power to devices installed in the satellite 620.

The surveillance device 626 monitors objects. Specifically, the surveillance device 626 monitors or observes objects, such as space objects, flying objects, or land, sea, and air mobile objects. The surveillance device 626 is also referred to as an observation device. The surveillance device 626 is, for example, an infrared surveillance device that detects a temperature rise due to atmospheric friction when a flying object enters the atmosphere by using infrared rays. The surveillance device 626 detects the temperature of a plume or a flying object body when the flying object is launched. Alternatively, the surveillance device 626 may be an information gathering device for light waves or radio waves. The surveillance device 626 may detect objects by using an optical system. The surveillance device 626 takes an image of an object flying at an altitude that differs from the orbital altitude of the observation satellite by using an optical system. Specifically, the surveillance device 626 may be a visible light sensor.

The processing circuit provided in the satellite control device 621 will be described. The processing circuit may be dedicated hardware or a processor that executes programs stored in the memory. Some functions of the processing circuit may be implemented as dedicated hardware and the remaining function may be implemented as software or firmware. That is, the processing circuit can be implemented as hardware, software, firmware, or a combination thereof Specifically, the dedicated hardware is a single circuit, a complex circuit, a programmed processor, a parallelly-programmed processor, an ASIC, an FPGA, or a combination thereof ASIC is an abbreviation for Application Specific Integrated Circuit. FPGA is an abbreviation for Field Programmable Gate Array.

### Method of Forming a Satellite Constellation

The satellite constellation 610 formed by the satellite constellation system 600 will be described. The satellite constellation 610 is formed by controlling the satellite 620 through the ground facility 700.

The communication route search method 471 will be described with reference to FIG. 1. The communication route search method 471 is a method used by a flying object coping system 370 to transmit the flying object surveillance information obtained by, for example, a surveillance satellite 100-0 of a surveillance satellite constellation 610A to another surveillance satellite (for example, a surveillance satellite 100-k) or a coping asset 332 by using a communication satellite constellation 610B as a transmission path and to cope with the flying object surveillance information before a flying object 520 lands by the coping asset 332. The surveillance satellite constellation 610A has the plurality of surveillance satellites 100 having infrared surveillance devices. In the communication satellite constellation 610B, the communication satellite group, which includes a plurality of communication satellites 200, flies on the individual orbital planes of the plurality of orbital planes, and the communication satellites 200 form a cross-link to each other to form a communication network. The flying object coping system 370 has a ground system 340 and performs coping by using the coping asset 332 before the flying object 520 lands. The communication route search method 471 is a communication route search method that searches for the shortest communication route among the communication routes of the communication satellite group. As illustrated in FIG. 1, the flying object coping system 370 and the coping asset 332 are disposed on the earth 510.

The ground system 340 includes a communication route search device 470 and a model database 350.

The communication route search device 470 analyzes the communication satellite IDs of the individual communication satellites 200 of the plurality of communication satellites 200 that form the communication path through which flying object surveillance information is transmitted from, for example, the surveillance satellite 100-0 to another surveillance satellite 100-k in the shortest route, the order of the communication satellite IDs of the plurality of communication satellites 200 in which the flying object surveillance information chronologically passes through the plurality of communication satellites 200, and the times at which the communication satellites 200 of the plurality of communication satellites 200 communicate with each other.

The model database 350 stores a plurality of flight path models that are a plurality of modeled flight paths including the launch position coordinates, the flight direction, the chronological flight distance from launch to landing, and the flight altitude profile of the flying object 520.

The communication route search device 470 selects a subsequent surveillance satellite that can monitor the flight path at a predicted time by using the plurality of flight path models in the model database 350, starting at the launch detection information of the flying object 520 detected by the infrared surveillance device of the surveillance satellite 100-0.

The communication route search device 470 performs a shortest route search for transmitting information, to a subsequent surveillance satellite 100-1, from the surveillance satellite 100-0 having an infrared surveillance device that detected the launch detection information of the flying object 520. The communication route search device 470 selects the next subsequent surveillance satellite 100-k that can monitor the flight path at a predicted time by using the flight path model as a candidate based on the flying object surveillance information detected by the subsequent surveillance satellite 100-1.

Then, the communication route search device 470 performs a shortest route search for transmitting information from the subsequent surveillance satellite 100-k to the next subsequent surveillance satellite 100-k+1.

After that, the communication route search device 470 repeats a shortest route search for transmitting information to a surveillance satellite 100 that can monitor the flying object 520 and searches for the shortest route through which information is transmitted from the last subsequent surveillance satellite 100-N in the shortest route search to the coping asset 332 that can cope with the flying object 520.

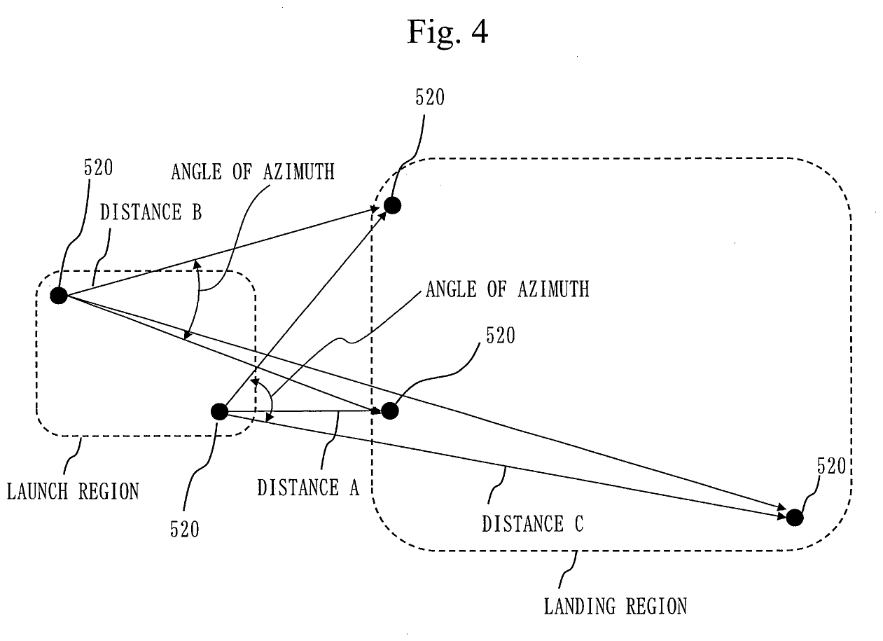

FIG. 4 illustrates an example of a flight path model of a ballistic flying object 521 as viewed from a certain altitude. FIG. 4 illustrates the launch region and the landing region of the ballistic flying object 521.

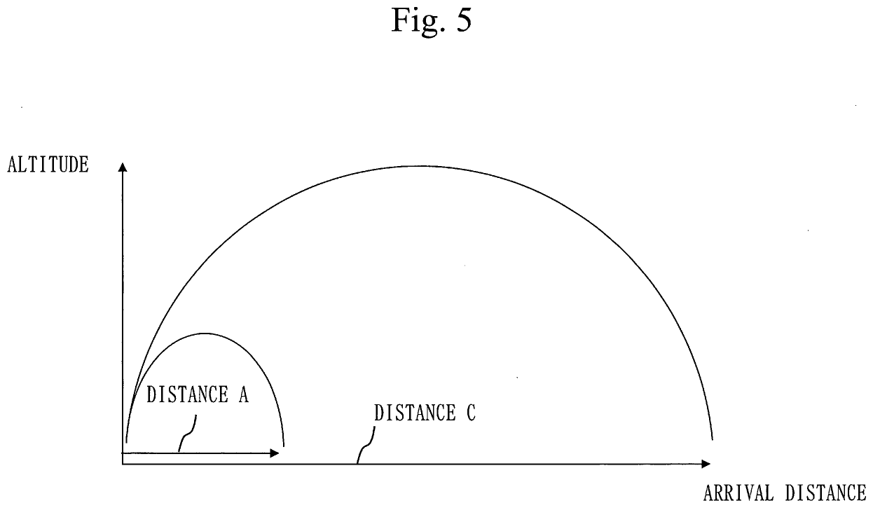

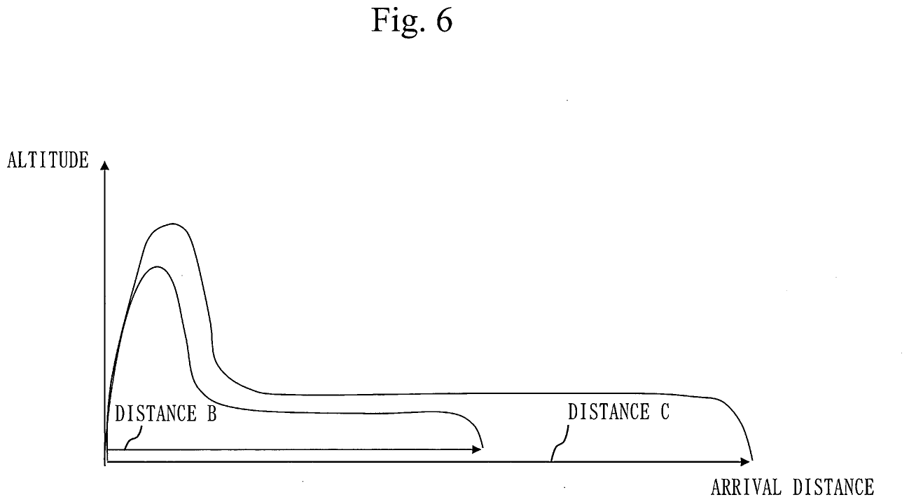

FIG. 5 illustrates an example of a flight path model of the ballistic flying object 521 represented by the distance direction and the height direction. In FIG. 5, the horizontal axis indicates the flight distance of the ballistic flying object 521, and the vertical axis indicates the altitude of the ballistic flying object 521. FIG. 6 illustrates a flight path model of a flying object that performs an intermittent injection. FIG. 6 corresponds to FIG. 5. In FIG. 6, the horizontal axis indicates the flight distance of a flying object that performs an intermittent injection, and the vertical axis indicates the altitude of the flying object that performs an intermittent injection.

As illustrated in FIG. 2, the launch region in which launch is expected and the landing region in which landing is expected can be assumed in advance for the flying object 520 that represents a security threat. Accordingly, it is possible to set a typical flight path model including the distance from the launch region to the landing region, the flight direction, the arrival time, the orbit and the arrival altitude in the case of ballistic flight, and the like. In recent years, a flying object called a glide bullet, which repeats an intermittent injection, has emerged. This glide bullet has more variations in flight path models than a ballistic bullet. However, in the glide bullet as well, a flight path model that reaches the landing region can be assumed as a flying model that glides in an upper atmosphere unit after completion of the injection at launch. Even if there is a deviation from a flight path model due to intermittent injection in the glide bullet, the amounts of change in the altitude direction and in the horizontal direction are small compared with the entire profile of the flight path from launch to landing. Accordingly, in the case of the glide bullet, the accuracy of prediction of the flight path can be improved by correcting the actual orbit based on the measurement information from the surveillance satellite by assuming a typical flight path model to be a provisional flight path.

In the prediction process of this flight path, it is necessary to search for a communication route for transmitting the information of a flying object for which the flight path is unknown at the time of launch through a subsequent surveillance satellite. Accordingly, a flight path model is used to search for a communication route by selecting a subsequent surveillance satellite that can obtain the next surveillance information according to the flight distance that depends on the lapse of time after the launch of the flying object. Since the travel distance is small immediately after the detection of launch, there is little divergence among a plurality of flight path models, and the next surveillance satellite can be easily selected. Since the flight direction of the flying object can be identified according to the flying object information from the subsequent surveillance satellite, the unapplicable flight path models can be eliminated, and the selection range of the next subsequent surveillance satellites can be reduced. Since the flight distance of the flying object 520 becomes greater and the flight direction can be accurately grasped as time further passes, the applicable flight models are limited.

The flight path model carefully selected after repetition of this operation is provisional flight path prediction, the result of improved accuracy based on the obtained information from the surveillance satellite becomes the final flight path prediction result, and the coping asset can be selected in the vicinity of the prediction route.

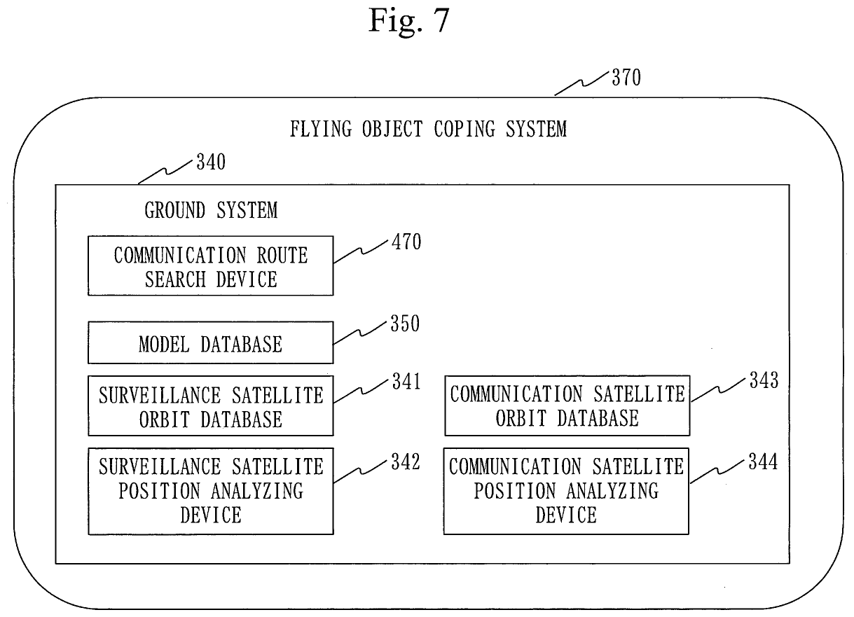

FIG. 7 illustrates the block structure of the ground system 340. Referring to FIG. 7, the ground system 340 includes a surveillance satellite orbit database 341 that records the orbit information of the surveillance satellite 100 for each of the surveillance satellite IDs of the individual surveillance satellites of the plurality of surveillance satellites 100, and a surveillance satellite position analyzing device 342 that derives the flight positions of the individual surveillance satellites of the plurality of surveillance satellites in real time.

The orbit information of the surveillance satellites contains the following information, which is referred to as six Keplerian orbital elements.
Epoch: Epoch (year and date)
Mean motion (m): Mean Motion (laps/day) or Semi-major axis Semi-major Axis (km)
Eccentricity (e): Eccentricity (no unit)
Orbit inclination (i): Inclination (degree)
Right ascension of ascending node (Ω): RAAN (Right Ascension of Ascending Node) (degree)
Argument of perigee (ω): Argument of Perigee (degree)
Mean anomaly (M): Mean Anomaly (degree)

The flight positions of the surveillance satellites 100 are derived for each of the surveillance satellite IDs based on the position coordinates of the earth-fixed coordinate system WGS84 or the like.

The surveillance satellite position analyzing device 342 can derive the chronological flight position coordinates of the surveillance satellites after the flying object is launched. Accordingly, based on the prediction result of the flight path of the flying object 520 separately obtained by the ground system 340, the surveillance satellite position analyzing device 342 can select the surveillance satellite 100 that passes in the vicinity for each of the chronological flight positions of the flying object 520 and can select the surveillance device that can grasp the flying object in the field of view of the surveillance device of the surveillance satellite 100.

The surveillance satellite position analyzing device 342 selects the surveillance satellite that passes in the vicinity of the flying object when the surveillance device of the surveillance satellite 100 is oriented in the geocentric direction.

The surveillance satellite position analyzing device 342 only needs to select the surveillance satellite that is apart from the flight position of the flying object by 50±20 degrees in the latitude direction or 50±20 degrees in the longitude direction when the surveillance device performs limb observation while being oriented toward the periphery of the earth. The optimal field of view for limb observation varies depending on the orbit altitude of the surveillance satellite and the arrival altitude of the flying object. When the surveillance satellite flies in an equatorial orbit or in the vicinity of the equator in an inclined orbit, it is possible to perform limb observation of the flying object that flies from west to east above a mid-latitude zone at approximately 40 degrees latitude. When the surveillance satellite flies in the vicinity of the northern extremity of the orbital plane in an inclined orbit, it is possible to perform limb observation of the flying object that is 50±20 degrees apart in the longitude direction. It is appreciated that, even when the surveillance device flies in a mid-latitude zone in an inclined orbit, it is possible to perform limb observation of the flying object relatively apart by 50±20 degrees about the center of the earth.

Referring to FIG. 7, the ground system 340 includes a communication satellite orbit database 343 that records the orbit information of the communication satellite 200 for each of the communication satellite IDs of the individual communication satellites 200 of the plurality of communication satellites 200, and a communication satellite position analyzing device 344 that derives the flight positions of the individual communication satellites of the plurality of communication satellites in real time.

The orbit information of the communication satellites 200 contains the following information, which is referred to as six Keplerian orbital elements.
Epoch: Epoch (year and date)
Mean motion (m): Mean Motion (laps/day) or Semi-major axis Semi-major Axis (km)
Eccentricity (e): Eccentricity (no unit)
Orbit inclination (i): Inclination (degree)
Right ascension of ascending node (Ω): RAAN (Right Ascension of Ascending Node) (degree)
Argument of perigee (ω): Argument of Perigee (degree)
Mean anomaly (M): Mean Anomaly (degree)

The flight positions of the communication satellites 200 are derived for each of the satellite IDs of the communication satellites 200 based on the position coordinates of the earth-fixed coordinate system WGS84 or the like.

The communication satellite position analyzing device 344 can derive the chronological flight position coordinates of the communication satellites 200 after the flying object is launched. Accordingly, when the surveillance satellite 100 that can monitor the flying object 520 at a specific time is selected based on the prediction result of the flight path of the flying object 520 separately obtained by the ground system 340, the communication satellite 200 that flies in the vicinity of the surveillance satellite 100 at that time can be selected. The surveillance satellite flying in the vicinity of the equator or the communication satellite flying in the vicinity of the surveillance satellite 50±20 degrees apart in the longitude direction only needs to be selected by using the chronological results of selection of the surveillance satellites derived by the surveillance satellite position analyzing device 342.

FIG. 1 illustrates the conceptual structure of the surveillance satellite constellation 610A, but in the specific structure of the surveillance satellite constellation 610A, the positions of the surveillance satellites 100 that fly on the individual orbital planes of the plurality of orbital planes can be synchronized with each other on the individual orbital planes of the plurality of orbital planes.

It is assumed that, on the plurality of orbital planes evenly disposed in the longitude direction of an inclined orbit constellation, for example, the satellites passing above the equator on all orbits are synchronized with each other and, within the individual orbital planes, the flight positions of the plurality of satellites are evenly disposed within the planes.

In this state, the time intervals at which the flying object flying at a constant speed from west to east passes in the vicinity of the individual orbital planes of the surveillance satellite constellation 610A become constant, and the in-plane phase positions in which the satellites flying within a specific orbital plane at constant time intervals move can also be easily predicted. Accordingly, the surveillance satellite that flies at the position suitable for future surveillance can be easily selected. Therefore, in a security emergency situation, there is an effect of enabling the selection of the surveillance satellite quickly. In addition, there is also an effect of simplifying the algorithm of the surveillance satellite position analyzing device.

In addition, in the communication satellite constellation 610B illustrated in FIG. 1, as in surveillance satellite constellation 610A, the positions of the communication satellites 200 that fly on the individual orbital planes of the plurality of orbital planes may be synchronized with each other on the individual orbital planes of the plurality of orbital planes. It is assumed that, on a plurality of orbital planes evenly disposed in the longitude direction of an inclined orbit constellation, for example, the communication satellites 200 passing above the equator on all orbits are synchronized with each other and, within the individual orbital planes, the flight positions of the plurality of communication satellites 200 are evenly disposed within the planes. In this case, the time intervals at which the flying object flying at a constant speed from west to east passes in the vicinity of the individual orbital planes of the communication satellite constellation 610B become constant, and the in-plane phase positions in which the satellites flying within a specific orbital plane at constant time intervals move can also be easily predicted. Accordingly, the communication satellite can be easily selected. Therefore, in a security emergency situation, there is an effect of enabling the selection of the communication satellite quickly. There is an effect of simplifying the algorithm of the communication satellite position analyzing device 344.

It should be noted that the communication route search device 470 is independent from the surveillance satellite position analyzing device 342 in FIG. 7, but the communication route search device 470 may have the surveillance satellite position analyzing device 342.

It should be noted that the communication route search device 470 is independent from the communication satellite position analyzing device 344 in FIG. 7, but the communication route search device 470 may have the communication satellite position analyzing device 344.

### Effects of Embodiment 1

In the communication route search method, the ground system, the surveillance satellite constellation, the communication satellite constellation, and the flying object coping system according to Embodiment 1, it is possible to provide the communication route search method that can quickly and accurately search for the communication route for transmitting the flying object information detected by the surveillance satellite.

### Embodiment 2

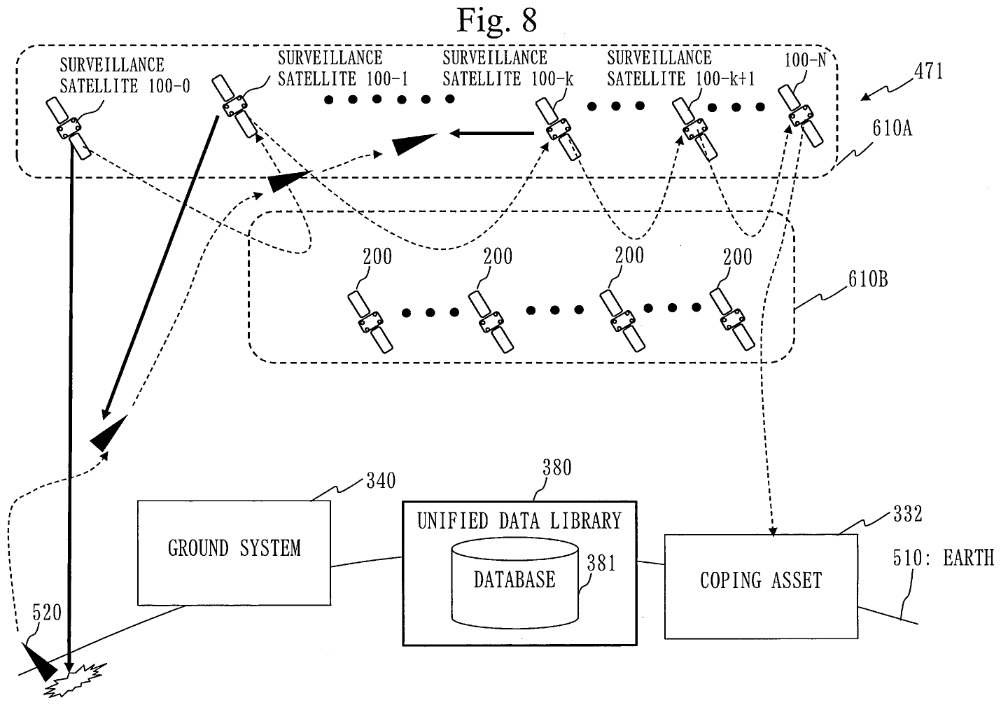

Embodiment 2 will be described with reference to FIGS. 8 to 12. In Embodiment 2, a unified data library 380 having a database 381, a satellite having an edge server 388 with a database 381, a satellite having an artificial intelligence calculator 391, and a satellite constellation that forms a hybrid constellation will be described.

### Unified Data Library 380

With the diversification of threats in recent years and the diversification of surveillance systems, communication systems, and coping systems, the need for Joint All domain Command & Control (JADC2) in which various ground centers operate using a common database is rising.

The ground center may be read as a domain. Information sharing of a database to be used in common can be made at various ground centers as a Unified Data Libraly (UDL) in a cloud environment or an edge computing environment. Furthermore, a space data center concept using satellite IoT has been proposed, and space data centers can share information similarly.

### Unified Data Library

FIG. 8 illustrates the unified data library 380 according to Embodiment 2.

The unified data library 380 is a library referenced by at least one of the surveillance satellite 100, the communication satellite 200, and the ground system 340 in the communication route search method according to Embodiment 1.

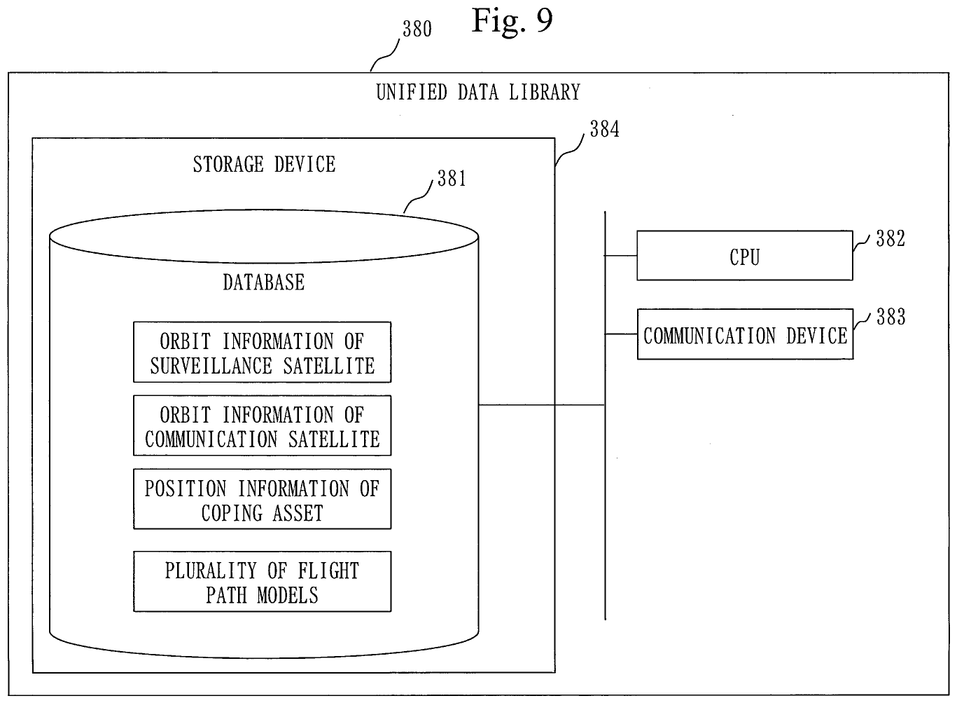

As illustrated in FIG. 9 below, the unified data library 380 has the database 381 that stores at least one of
the orbit information of the surveillance satellite 100,
the orbit information of the communication satellite 200,
the position information of the coping asset 332, and
a plurality of flight path models.

Here, the plurality of flight path models are models including the launch position coordinates, the flight direction, the chronological flight distance from launch to landing, and the flight altitude profile of the flying object 520, and the plurality of models formed by modeling the flight path.

The unified data library 380 is disposed on the ground as illustrated in FIG. 8, but the unified data library 380 may be disposed on a satellite.

FIG. 9 illustrates the hardware structure of the unified data library 380. The unified data library 380 is a computer. The unified data library 380 includes a CPU 382, a communication device 383, and a storage device 384. The storage device 384 implements the database 381.

### Cloud Computing: Satellite Having Edge Server 388

With an increase in the amount of information together with the sophistication of the information society, an increase in power consumption and countermeasures against exhaust heat have become issues. In particular, in centralized systems, high power consumption of super computers and large-scale data centers and countermeasures against exhaust heat become serious problems.

In contrast, in outer space, heat can be exhausted to deep space by radiative cooling. Accordingly, if super computers or data centers for achieving a cloud environment are disposed on a satellite constellation, only necessary data can be transmitted to users on the ground after arithmetic processing is performed in orbit. This has an effect of contributing to SDGs on the ground by maintaining the cloud environment and reducing the amount of emission of greenhouse effect gases.

### Edge Computing

Edge computing, in which the edge server is disposed on the IoT side, is attracting attention as a method of achieving a distributed architecture.

In conventional IoT, centralized systems that send the data collected by sensors to a cloud via the Internet to perform analysis are general. In contrast, edge computing achieves real-time and low-load data processing by performing data processing in a distributed manner by using an edge server installed in a device body or between a device and a cloud.

With an increase in the amount of information together with the sophistication of the information society, an increase in power consumption and countermeasures against exhaust heat have become issues. In particular, in centralized systems, high power consumption of super computers and large-scale data centers and countermeasures against exhaust heat become serious problems.

In contrast, since heat can be exhausted to deep space by radiative cooling in outer space, it is rational to consider satellites as devices in IoT, dispose an edge server on the satellite constellation, perform distributed computing processing in orbit, and then transmit only the necessary data to the ground. The hybrid constellation has the effect of achieving low latency and centralized data management by exchanging information with the cloud having a data center in the ground facility 700 via a ring communication network or a mesh communication network.

In FIG. 8, at least one of the surveillance satellite 100 and the communication satellite 200 in the communication route search method according to Embodiment 1 may include the edge server 388 having the database 381.

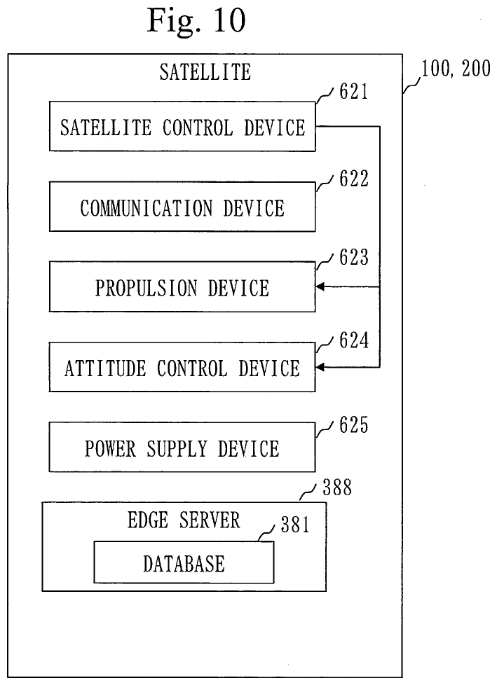

FIG. 10 illustrates a structure in which the surveillance satellite 100 or the communication satellite 200 has the edge server 388 with the database 381. It should be noted that the surveillance device of the surveillance satellite 100 is not illustrated in FIG. 10. The hardware structure of the edge server 388 is similar to that of the unified data library 380 in FIG. 9.

### Artificial Intelligence Calculator

Artificial intelligence will be described below. Artificial intelligence is often referred to as AI.

Neural networks of artificial intelligence can be classified into supervised learning, which optimizes a problem by inputting a teacher signal (correct answer), and unsupervised learning, which does not require a teacher signal.

Learning of flying object types, propellant types, and a plurality of typical patterns of flying models as teacher models in advance makes inference of actual measurement data including orbit information by detecting launch easy and quick. As a result of inference, the flying object path is predicted and the landing position is estimated.

However, when the flight path of a flying object for which the flight direction is unknown is predicted at the stage of launch detection, the subsequent surveillance satellite needs to track and monitor the flying object. In addition, when launch detection information is sent to the subsequent surveillance satellite, the launch detection information needs to go through a communication network formed by a communication satellite group.

In a communication network formed by the communication satellite constellation, since the flight positions of the communication satellites change from moment to moment, the IDs of the communication satellites with which the flying object information is exchanged and the time at which the flying object information is exchanged need to be determined by an optimum communication route search. This situation is similar when the surveillance satellites and the communication satellites exchange flying object information.

When an optimal route search is performed by the ground system, the times at which the flying object information is exchanged and the satellite IDs of the satellites with which the flying object information is exchanged need to be sent to the surveillance satellites and the communication satellites by using commands. However, the communication network for sending the commands becomes a problem.

Accordingly, it is rational for the communication satellites to have AI-based analyzing devices, perform an optimum route search in orbit, and generate commands to the communication satellites that constitute the communication route in orbit to perform communication.

An optimum route search that uses an algorithm known as the Dijkstra method is effective as a method for searching for the optimum route in orbit. It should be noted that weighting for each route does not change in the static Dijkstra method, but for a communication network formed by a communication satellite constellation, weighting for each route changes over time due to changes in the flight position of the communication satellite. Accordingly, the operation is repeated in which, for each of the communication satellites that perform an optimum route search while updating orbit information, the communication satellite having received the flying object information performs an optimum route search and sends the flying object information to the next communication satellite.

In addition, a breadth-first search and a depth-first search are known as route searches. It is rational that, for launch detection information, priority is given to quick transmission of flying object information to a communication network by a breadth-first search, tracking is repeated in subsequent satellites, and a depth-first search is performed at the stage at which the flight direction can be roughly estimated.

The flying object tracking system tracks and monitors the flying object while repeating the flight path prediction by the machine learning and a route search by the Dijkstra method described above to infer the final landing position.

Furthermore, after repeating the flying object tracking, the machine learning is applied to the results of past flying object tracking and deep learning is applied to the cases of flying object behaviors that differ from the plurality of flying object models used as teacher models. This can improve the accuracy of the prediction of the route of a flying object and speed up the prediction.

Since there is a difference between the flight direction and the flight distance of a flying object launched from a transporter erector launcher (TEL) or the like instead of a fixed launcher and those of a typical flying model, it is effective to complement the orbit model by deep learning on actual measurement data.

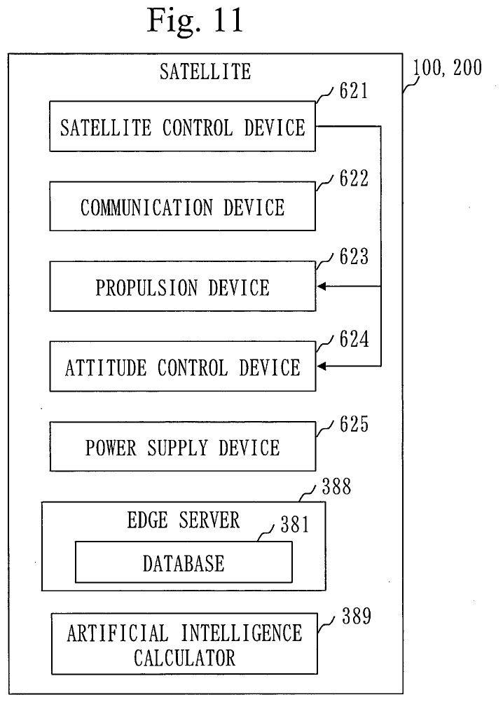

FIG. 11 illustrates a structure in which the surveillance satellite 100 includes an artificial intelligence calculator 389. The surveillance satellite 100 or the communication satellite 200 that has the edge server 388 with the database 381 may have the artificial intelligence calculator 389 instead. The artificial intelligence calculator 389 autonomously determines the transmission destination of the flying object information by referencing the database 381 and sends the flying object information to the determined transmission destination. The artificial intelligence calculator has the effects described in <Artificial intelligence calculator>above.

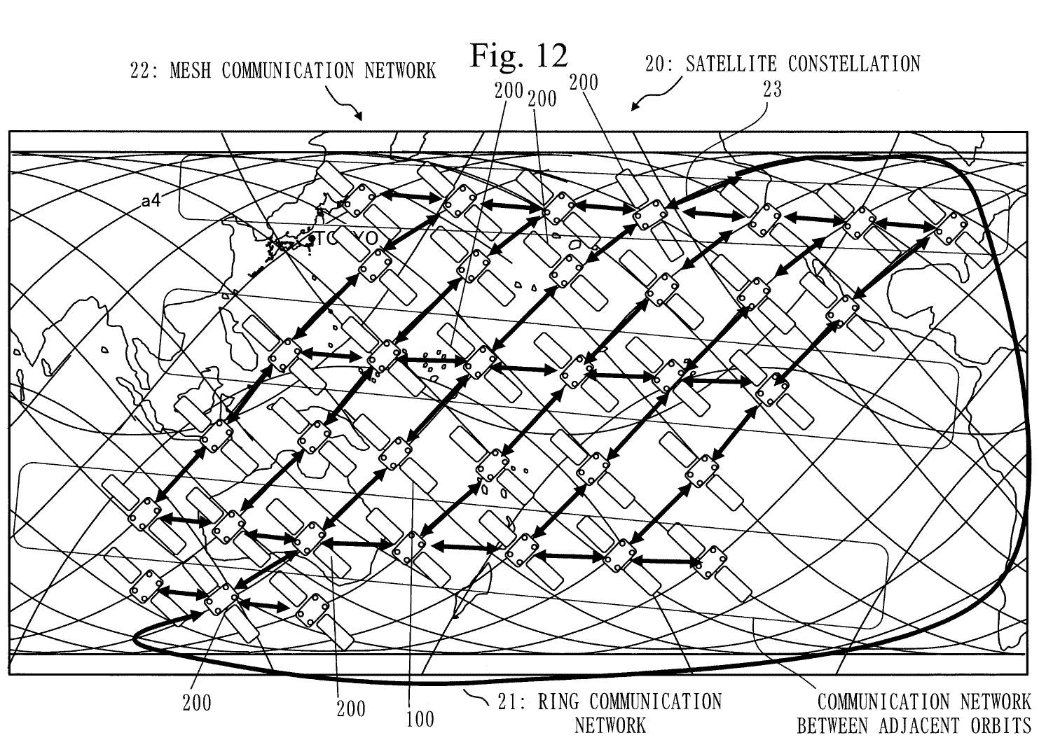

FIG. 12 illustrates a satellite constellation 20 according to Embodiment 2. As the satellite constellation 20 including the surveillance satellite 100 and the communication satellites 200 that constitute the flying object tracking system that detects launch of a flying object and tracks the flying object by using the flight path prediction method described in Embodiment 1, the satellite constellation in FIG. 12 is configured in Embodiment 2. The satellite constellation in FIG. 12 will be described below.

The plurality of communication satellites 200 each having a communication device communicating with the front and rear satellites in the forwarding direction on the same orbital plane form a communication constellation of a ring communication network 21.

In addition, the surveillance satellite 100 having a communication device communicating with the front and rear satellites flies among the plurality of communication satellites 200 that form the communication constellation of the ring communication network 21. FIG. 12 illustrates a same orbital plane 23 as a representative of the same orbital plane.

The surveillance satellite 100 and the plurality of communication satellites 200 that form the communication constellation reconstruct the ring communication network 21 or reconstruct a mesh communication network 22 connected to an adjacent orbit to form a hybrid surveillance-communication constellation.

A hybrid constellation indicates a constellation that achieves a plurality of missions including a non-communication mission such as observation or positioning and a communication mission, the constellation being formed when communication satellites that form a communication network have devices for non-communication missions such as observation and positioning missions at the same time or when a non-communication satellite such as an observation satellite and a positioning satellite has a communication device that forms a part of the communication network at the same time. Information can be exchanged between the ground user and the hybrid constellation via the ring communication network 21 or the mesh communication network 22. In addition, there is an effect of achieving centralized data management of the satellites constituting the hybrid constellation and distributed computing regarded as IoT (Internet of Things) with low latency. Some functions of a cloud data center, which was conventionally installed on the ground, are installed on a satellite as a space data center. In addition, there is an effect of contributing to the reduction in the burden on ground processing by performing certain processing in orbit and transmitting only the processing result to the ground. For example, a shortest route search is rational when the orbit information of individual communication satellites that constitute the communication satellite constellation is summarized by the space data center and the information is transmitted via a ring communication network or a mesh communication network formed by the communication satellite constellation. In the conventional technology, collected orbit information is transmitted from the satellite to the ground, and the information is analyzed and evaluated on the ground and then sent to the satellite. By autonomously performing this processing in outer space, the amount of data is reduced and the burden of ground processing is reduced.

### Reference Signs List

21: ring communication network; 22: mesh communication network; 23: orbital plane; 100: surveillance satellite; 101: first infrared surveillance device; 102: second infrared surveillance device; 200: communication satellite; 332: coping asset; 340: ground system; 341: surveillance satellite orbit database; 342: surveillance satellite position analyzing device; 343: communication satellite orbit database; 344: communication satellite position analyzing device; 380: unified data library; 381: database; 382: CPU; 383: communication device; 384: storage device; 388: edge server; 389: artificial intelligence calculator; 390: flying object coping system; 470: communication route search device; 471: communication route search method; 510: the earth; 520: flying object; 610: satellite constellation; 610A: surveillance satellite constellation; 610B: communication satellite constellation; 620: satellite; 621: satellite control device; 622: communication device; 623: propulsion device; 624: attitude control device; 625: power supply device; 626: surveillance device; 700: ground. facility; 910: processor; 911: satellite constellation forming unit; 921: memory; 922: auxiliary storage device; 930: input interface; 940: output interface; 950: communication device

1. A communication route search method of searching for a shortest communication route among communication routes of a communication satellite group including a plurality of communication satellites, the communication route search method being used by a flying object coping system that performs coping by using a coping asset before landing of a flying object, by transmitting flying object surveillance information obtained by a surveillance satellite of a surveillance satellite constellation including a plurality of surveillance satellites each having an infrared surveillance device to another surveillance satellite and the coping asset by using, as a transmission path, a communication satellite constellation in which the communication satellite group flies on individual orbital planes of a plurality of orbital planes and the communication satellites form a cross-link to each other to form a communication network, and the flying object coping system having a ground system, wherein
the ground system has
a communication route search device to analyze
communication satellite IDs of individual communication satellites of the plurality of communication satellites that form a communication path through which the flying object surveillance information is transmitted from the surveillance satellite to the other surveillance satellite in a shortest route,
an order of the communication satellite IDs of the plurality of communication satellites in which the flying object surveillance information chronologically passes through the plurality of communication satellites, and
times at which the individual communication satellites of the plurality of communication satellites communicate with each other, and
a model database to store a plurality of flight path models that are a plurality of modeled flight paths each including launch position coordinates, a flight direction, a chronological flight distance from launch to landing, and flight altitude profile of the flying object,
the communication route search device
selects a subsequent surveillance satellite that can monitor a flight path at a predicted time by using the plurality of flight path models, starting at launch detection information of the flying object detected by the infrared surveillance device of the surveillance satellite,
performs a shortest route search for transmitting information, to the subsequent surveillance satellite, from the surveillance satellite having the infrared surveillance device that detected the launch detection information of the flying object,
selects a next subsequent surveillance satellite that can monitor the flight path at a predicted time by using the flight path model as a candidate based on the flying object surveillance information detected by the subsequent surveillance satellite,
performs a shortest route search for transmitting information from the subsequent surveillance satellite to the next subsequent surveillance satellite, and
repeats the shortest route search for transmitting information to the surveillance satellite that can monitor the flying object and searches for a shortest route through which information is transmitted from a last subsequent surveillance satellite in the shortest route search to the coping asset that can cope with the flying object.

2. A ground system of the flying object coping system that uses the communication route search method according to claim 1.

3. The ground system according to claim 2, comprising:
a surveillance satellite orbit database to record orbit information of the surveillance satellite for each of surveillance satellite IDs of individual surveillance satellites of the plurality of surveillance satellites; and
a surveillance satellite position analyzing device to derive flight positions of the individual surveillance satellites of the plurality of surveillance satellites in real time.

4. The ground system according to claim 2, comprising:
a communication satellite orbit database to record orbit information of the communication satellite for each of the communication satellite IDs of the individual communication satellites of the plurality of communication satellites; and
a communication satellite position analyzing device to derive flight positions of the individual communication satellites of the plurality of communication satellites in real time.

5. A surveillance satellite constellation used by the flying object coping system that uses the communication route search method according to claim 1, wherein
positions of the surveillance satellites that fly on individual orbital planes of a plurality of orbital planes are synchronized with each other on the individual orbital planes of the plurality of orbital planes.

6. A communication satellite constellation used by the flying object coping system that uses the communication route search method according to claim 1, wherein
positions of the communication satellites that fly on individual orbital planes of a plurality of orbital planes are synchronized with each other on the individual orbital planes of the plurality of orbital planes.

7. The ground system according to claim 3, wherein
the communication route search device includes the surveillance satellite position analyzing device.

8. The ground system according to claim 4, wherein
the communication route search device includes the communication satellite position analyzing device.

9. The flying object coping system to use the communication route search method according to claim 1.

10. A unified data library referenced by at least one of the surveillance satellite, the communication satellite, and the ground system in the communication route search method according to claim 1, wherein
the unified data library has a database that stores at least one of
orbit information of the surveillance satellite,
orbit information of the communication satellite,
position information of the coping asset, and
a plurality of flight path models formed by launch position coordinates, a flight direction, a chronological flight distance from launch to landing, and a flight altitude profile of the flying object, the flight path models being formed by modeling flight paths.

11. A satellite that is one of the surveillance satellite and the communication satellite in the communication route search method according to claim 1, wherein
the satellite includes an edge server having a database that stores at least one of
orbit information of the surveillance satellite,
orbit information of the communication satellite,
position information of the coping asset, and
a plurality of flight path models formed by launch position coordinates, a flight direction, a chronological flight distance from launch to landing, and a flight altitude profile of the flying object, the flight path models being formed by modeling flight paths.

12. The satellite including the edge server having the database according to claim 11, comprising:
an artificial intelligence calculator to autonomously determine a transmission destination of the flying object surveillance information by referencing the database and to send the flying object surveillance information to the determined transmission destination.

13. A satellite constellation including the surveillance satellite and the communication satellite that constitute a flying object tracking system to detect launch of the flying object and to track the flying object by using the communication route search method according to claim 1, wherein
a plurality of communication satellites each having a communication device to communicate with front and rear communication satellites in a forwarding direction on a single orbital plane form a communication constellation of a ring communication network, and
the surveillance satellite having a communication device to communicate with the front and rear communication satellites flies among the plurality of communication satellites that form the communication constellation, and
the surveillance satellite and the plurality of communication satellites that form the communication constellation reconstruct the ring communication network or reconstruct a mesh communication network connected to an adjacent orbit to form a hybrid surveillance-communication constellation.

14. The ground system according to claim 3, comprising:
a communication satellite orbit database to record orbit information of the communication satellite for each of the communication satellite IDs of the individual communication satellites of the plurality of communication satellites; and
a communication satellite position analyzing device to derive flight positions of the individual communication satellites of the plurality of communication satellites in real time.
